(19) United States
(12) Patent Application Publication
(10) Pub. No.: US 2023/0188477 A1
(43) Pub. Date: Jun. 15, 2023

(54) SYSTEMS AND METHODS FOR COMPUTING RESOURCE PROVISIONING

(71) Applicant: Citrix Systems, Inc., Fort Lauderdale, FL (US)

(72) Inventors: Zhen Zeng, Nanjing (CN); Zichao Xu, Nanjing (CN); Shuai Zhang, Nanjing (CN); Huihao Liao, Nanjing (CN); Ke Wang, Nanjing (CN)

(73) Assignee: Citrix Systems, Inc., Fort Lauderdale, FL (US)

(21) Appl. No.: 17/568,184

(22) Filed: Jan. 4, 2022

Related U.S. Application Data
(63) Continuation of application No. PCT/CN2021/136985, filed on Dec. 10, 2021.

(51) Int. Cl. H04L 47/80; H04L 47/762; H04L 47/78; H04L 47/70

(52) U.S. Cl. CPC H04L 47/808; H04L 47/762; H04L 47/781; H04L 47/822

(57) ABSTRACT

Described embodiments provide systems and methods for accessing resources. A computing device may receive a first request to access a resource, the resource being executable on one or more servers and including data to provision the resource to one or more client devices. The computing device may determine that a relationship between a user of a client device and the resource exists that enables provision of the resource to the client device with use of first credentials defined by an administrative entity of the computing device. Responsive to the determination, the computing device may initiate a second request to provide a user interface through which to access the resource. The computing device may provide the user with access to the user interface responsive to authentication of the user with use of second credentials different from the first credentials.

### CROSS-REFERENCE TO RELATED APPLICATION

This application is a continuation of and claims priority to International Application No. PCT/CN2021/136985, titled “SYSTEMS AND METHODS FOR COMPUTING RESOURCE PROVISIONING,” and filed on Dec. 10, 2021, the contents of all of which are hereby incorporated herein by reference in its entirety for all purposes.

### FIELD OF THE DISCLOSURE

The present application generally relates to computing systems and environments, including but not limited to systems and methods for provisioning and/or accessing hosted resources.

### BACKGROUND

In current applications, resources are becoming increasingly ubiquitous. In some applications, a resource is provided by a service provider. Furthermore, current systems deliver or provision applications, desktops, containers and/or resources using disparate approaches (e.g., using separate, different or distinct approaches).

### SUMMARY

This Summary is provided to introduce a selection of concepts in a simplified form that are further described below in the Detailed Description. This Summary is not intended to identify key features or essential features, nor is it intended to limit the scope of the claims included herewith.

The present disclosure is directed towards systems and methods for provisioning and/or accessing computing resources (e.g., an application). For instance, the systems and methods described herein can provide a novel approach for efficiently managing, provisioning and/or accessing resources via a computing device through a user interface, according to a relationship between a user of a client device (e.g., a smartphone, a laptop, and/or a tablet device) and the resource(s). In certain embodiments, an administrative entity (e.g., an administrator and/or other entities, such as an administrative program) can provision and/or assign the resource to the user of the client device via the computing device. Responsive to said provisioning and/or assignments, the user may access, use, and/or utilize the resource(s) (e.g., through a user interface, with use of credentials) via a client device, without the user having to separately configure and/or access the corresponding resource and the user interface.

In one aspect, the present disclosure is directed to a method for accessing resources. The method can include receiving, by a computing device, a first request to access a resource, the resource being executable on one or more servers and including data to provision the resource to one or more client devices. The computing device may determine that a relationship between a user of a client device and the resource exists that enables provision of the resource to the client device with use of first credentials defined by an administrative entity of the computing device. Responsive to the determination, the computing device may initiate a second request to provide a user interface through which to access the resource. The computing device may provide the user with access to the user interface responsive to authentication of the user with use of second credentials different from the first credentials.

In certain embodiments, in response to determining that the relationship exists, the computing device may provide the first credentials to allow the user access to the resource. In some embodiments, the relationship may be preconfigured in a database, the database comprising a plurality of relationships, each being between at least one user and at least one resource. At least one resource may include the user interface. In certain embodiments, the first credentials may be configured for use in accordance with each of at least two of the plurality of relationships.

In some embodiments, the computing device may determine that a relationship between the resource and the user interface exists. The computing device may initiate the second request responsive to determining that the relationship between the resource and the user interface exists. In certain embodiments, the resource can execute on a first subset of the one or more servers. The user interface may execute on a second subset of the one or more servers that is different from the first subset. In some embodiments, the relationship may comprise a relationship between a group of users and the resource, the group of users including the user. In certain embodiments, the relationship may comprise a relationship between the user and a plurality of resources, the plurality of resources including the resource.

In one aspect, the present disclosure is directed to a computing device comprising at least one processor. The at least one processor may be configured to receive a first request to access a resource, the resource being executable on one or more servers and including data to provision the resource to one or more client devices. The at least one processor may be configured to determine that a relationship between a user of a client device and the resource exists that enables provision of the resource to the client device with use of first credentials defined by an administrative entity of the computing device. The at least one processor may be configured to initiate, responsive to the determination, a second request to provide a user interface through which to access the resource. The at least one processor may be configured to provide the user with access to the user interface responsive to authentication of the user with use of second credentials different from the first credentials.

In certain embodiments, the at least one processor can be configured to provide, in response to the determination, the first credentials to allow the user access to the resource. In some embodiments, the relationship may be preconfigured in a database, the database comprising a plurality of relationships, each being between at least one user and at least one resource. In certain embodiments, the at least one resource may include the user interface. In some embodiments, the first credentials may be configured for use in accordance with each of at least two of the plurality of relationships. In some embodiments, the at least one processor can be configured to determine that a relationship between the resource and the user interface exists. In certain embodiments, the at least one processor may be configured to initiate the second request responsive to determining that the relationship between the resource and the user interface exists. In certain embodiments, the resource may execute on a first subset of the one or more servers. In some embodiments, the user interface can execute on a second subset of the one or more servers that is different from the first subset. In some embodiments, the relationship may comprise a relationship between a group of users and the resource, the group of users including the user. In certain embodiments, the relationship may comprise a relationship between the user and a plurality of resources, the plurality of resources including the resource.

In one aspect, the present disclosure is directed to a non-transitory computer readable medium storing program instructions. The program instructions stored in a non-transitory computer readable medium may cause at least one processor to receive a first request via a receiver, to access a resource, the resource being executable on one or more servers and including data to provision the resource to one or more client devices. The program instructions may cause the at least one processor to determine that a relationship between a user of a client device and the resource exists that enables provision of the resource to the client device with use of first credentials defined by an administrative entity of the computing device. The program instructions may cause the at least one processor to initiate, responsive to the determination, a second request to provide a user interface through which to access the resource. The program instructions may cause the at least one processor to provide the user with access to the user interface responsive to authentication of the user with use of second credentials different from the first credentials. In certain embodiments, the program instructions may cause the at least one processor to determine that a relationship between the resource and the user interface exists. In certain embodiments, the program instructions may cause the at least one processor to initiate the second request responsive to determining that the relationship between the resource and the user interface exists.

### BRIEF DESCRIPTION OF THE DRAWING FIGURES

Objects, aspects, features, and advantages of embodiments disclosed herein will become more fully apparent from the following detailed description, the appended claims, and the accompanying drawing figures in which like reference numerals identify similar or identical elements. Reference numerals that are introduced in the specification in association with a drawing figure may be repeated in one or more subsequent figures without additional description in the specification in order to provide context for other features, and not every element may be labeled in every figure. The drawing figures are not necessarily to scale, emphasis instead being placed upon illustrating embodiments, principles and concepts. The drawings are not intended to limit the scope of the claims included herewith.

FIG. 1A is a block diagram of a network computing system, in accordance with an illustrative embodiment;

FIG. 1B is a block diagram of a network computing system for delivering a computing environment from a server to a client via an appliance, in accordance with an illustrative embodiment;

FIG. 1C is a block diagram of a computing device, in accordance with an illustrative embodiment;

FIG. 1D is a block diagram depicting a computing environment comprising client device in communication with cloud service providers, in accordance with an illustrative embodiment;

FIG. 2 is a block diagram of an appliance for processing communications between a client and a server, in accordance with an illustrative embodiment;

FIGS. 3, 4A and 4B are block diagrams of systems for accessing and/or provisioning computing resources, in accordance with illustrative embodiments;

FIG. 5 is a diagram of a process for accessing and/or provisioning resources, in accordance with an illustrative embodiment; and

FIG. 6 is a flow diagram of an example method for accessing and/or provisioning resources, in accordance with an illustrative embodiment.

### DETAILED DESCRIPTION

In current scenarios, management, provisioning and/or usage of resources (such as PaaS resource) is becoming increasingly ubiquitous. Traditionally, said resources (e.g., a container, a database and/or other resources) are managed, provisioned and/or created by a service provider (e.g. a PaaS service provider and/or other types of service providers), while users (e.g. users of client devices) can access and/or use the resources via a separate mechanism (e.g., access and/or use through a software development kit (SDK)). In certain scenarios, a plurality of users may separately identify, use and/or access a user interface (e.g., through which to access the resource) and/or the resource at a same time instance. Embodiments of the present disclosure can provide the users with simultaneous, streamlined or automatic access to the resource (e.g., a backend resource) and the user interface (e.g., a backend resource) while facilitating the associated authentication for the resource and for the user interface. For example, while resources in certain systems may not be able to leverage on role based access control (RBAC) mechanisms, the present systems and methods may allow authenticated users to trigger or perform one or more actions on the resources according to RBAC mechanisms, which may be based on the role, responsibility, title, permissions and/or position of the user within an enterprise and/or organization. Additionally or alternatively, the mechanisms for accessing a resource (e.g., backend resource) and a corresponding user interface (e.g. frontend resource) can be linked or integrated (e.g., via pre-configured mappings or relationships maintained in a database/storage), and can thus be triggered and automated via authorized relationships between the user, the resource and/or the user interface. As such, the systems and methods presented herein can provide one or more users with direct access to the resource (e.g., backend resource) and/or user interface (e.g., frontend resource), without having to manually and/or separately access and link the resource and the user interface.

In one example, and in some implementations, a user may be unable to directly access the resource, having to also access the user interface (e.g., a secure shell (SSH) console) and/or provide authentication credentials via a separate process (e.g., prior to accessing and/or using the corresponding resource). This can be because the resource (sometimes referred to as a backend resource), may provide the content and/or data structure for the content, but may rely on different user interface options/alternatives (sometimes referred to as frontend resources or consoles), that are available/suitable depending on user training/ability/preference/authorization to access (e.g., to retrieve, query, organize, render, present) the content. Moreover, such backend and frontend resources may be developed, maintained and/or provisioned by different (e.g., specialized) entities/providers/platforms/locations which are generally not integrated or coupled together. The systems and methods described herein can provide the user with streamlined or automatic access to the resource(s) upon reception of a request to access the resource(s), providing the user with direct access to the resource (e.g., through the user interface) upon authentication of the user (e.g., according to second credentials). Embodiments of the present disclosure describe a streamlined and/or automated process (e.g., automatic process requiring a single click) for providing the user with access to the resource (e.g., through the user interface) while performing user authentication, whereas other approaches require the user to perform a plurality of steps prior to accessing and/or using the resource (e.g., separate log-in to a console, navigate within the console to identify the resource, complete an authentication process for accessing the particular resource, and/or other steps). For example, because the console or frontend resource may be configured as a user interface that is not specific to only one backend resource, and which may be hosted on different servers/platforms than the user’s target backend resource, the targeted backend resource may have to be manually identified, accessed and loaded into the frontend resource. In some embodiments, the systems and methods described herein can store and use relationships (e.g., predefined or pre-established relationships) and/or authentication credentials between a user and a frontend resource, and between the frontend resource (and/or the user) and a backend resource, to pre-specify and facilitate simultaneous or automatic access to both the frontend and the backend resources by the user in a streamlined fashion, so that the user can efficiently and conveniently access the frontend resource via a user interface comprised in the backend resource.

For purposes of reading the description of the various embodiments below, the following descriptions of the sections of the specification and their respective contents may be helpful:

Section A describes a network environment and computing environment which may be useful for practicing embodiments described herein;

Section B describes embodiments of systems and methods for delivering a computing environment to a remote user;

Section C describes embodiments of systems and methods for accessing and/or provisioning resources.

### A. Network and Computing Environment

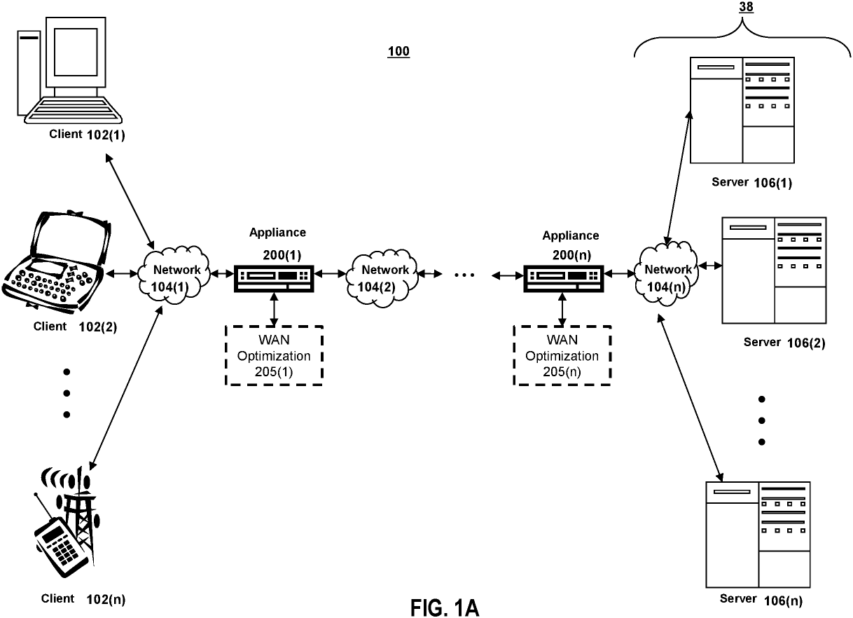

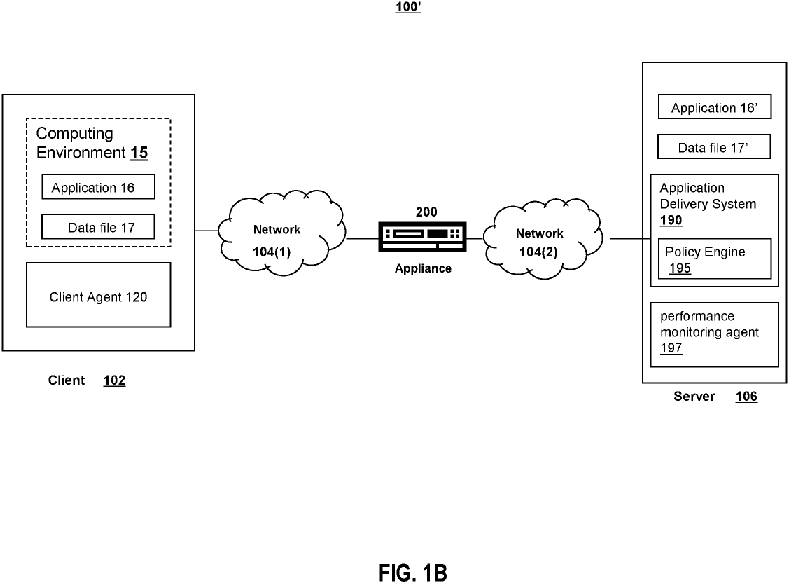

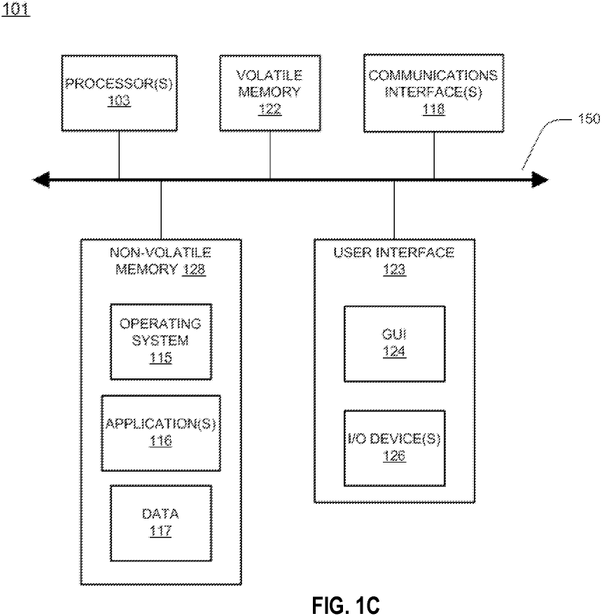

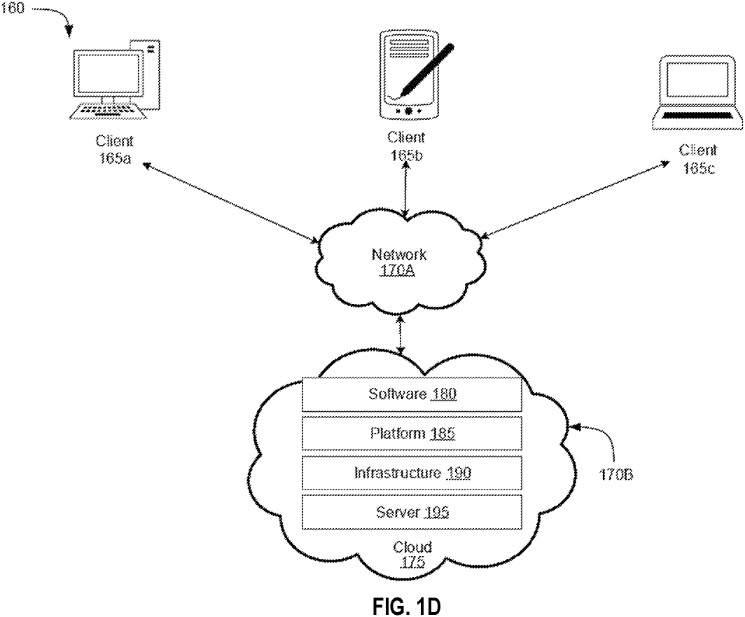

Referring to FIG. 1A, an illustrative network environment 100 is depicted. Network environment 100 may include one or more clients 102(1)-102(n) (also generally referred to as local machine(s) 102 or client(s) 102) in communication with one or more servers 106(1)-106(n) (also generally referred to as remote machine(s) 106 or server(s) 106) via one or more networks 104(1)-104n (generally referred to as network(s) 104). In some embodiments, a client 102 may communicate with a server 106 via one or more appliances 200(1)-200n (generally referred to as appliance(s) 200 or gateway(s) 200).

Although the embodiment shown in FIG. 1A shows one or more networks 104 between clients 102 and servers 106, in other embodiments, clients 102 and servers 106 may be on the same network 104. The various networks 104 may be the same type of network or different types of networks. For example, in some embodiments, network 104(1) may be a private network such as a local area network (LAN) or a company Intranet, while network 104(2) and/or network 104(n) may be a public network, such as a wide area network (WAN) or the Internet. In other embodiments, both network 104(1) and network 104(n) may be private networks. Networks 104 may employ one or more types of physical networks and/or network topologies, such as wired and/or wireless networks, and may employ one or more communication transport protocols, such as transmission control protocol (TCP), internet protocol (IP), user datagram protocol (UDP) or other similar protocols.

As shown in FIG. 1A, one or more appliances 200 may be located at various points or in various communication paths of network environment 100. For example, appliance 200 may be deployed between two networks 104(1) and 104(2), and appliances 200 may communicate with one another to work in conjunction to, for example, accelerate network traffic between clients 102 and servers 106. In other embodiments, the appliance 200 may be located on a network 104. For example, appliance 200 may be implemented as part of one of clients 102 and/or servers 106. In an embodiment, appliance 200 may be implemented as a network device such as Citrix networking (formerly NetScaler®) products sold by Citrix Systems, Inc. of Fort Lauderdale, FL.

As shown in FIG. 1A, one or more servers 106 may operate as a server farm 38. Servers 106 of server farm 38 may be logically grouped, and may either be geographically co-located (e.g., on premises) or geographically dispersed (e.g., cloud based) from clients 102 and/or other servers 106. In an embodiment, server farm 38 executes one or more applications on behalf of one or more of clients 102 (e.g., as an application server), although other uses are possible, such as a file server, gateway server, proxy server, or other similar server uses. Clients 102 may seek access to hosted applications on servers 106.

As shown in FIG. 1A, in some embodiments, appliances 200 may include, be replaced by, or be in communication with, one or more additional appliances, such as WAN optimization appliances 205(1)-205(n), referred to generally as WAN optimization appliance(s) 205. For example, WAN optimization appliance 205 may accelerate, cache, compress or otherwise optimize or improve performance, operation, flow control, or quality of service of network traffic, such as traffic to and/or from a WAN connection, such as optimizing Wide Area File Services (WAFS), accelerating Server Message Block (SMB) or Common Internet File System (CIFS). In some embodiments, appliance 205 may be a performance enhancing proxy or a WAN optimization controller. In one embodiment, appliance 205 may be implemented as Citrix SD-WAN products sold by Citrix Systems, Inc. of Fort Lauderdale, FL.

Referring to FIG. 1B, an example network environment, 100′, for delivering and/or operating a computing network environment on a client 102 is shown. As shown in FIG. 1B, a server 106 may include an application delivery system 190 for delivering a computing environment, application, and/or data files to one or more clients 102. Client 102 may include client agent 120 and computing environment 15. Computing environment 15 may execute or operate an application, 16, that accesses, processes or uses a data file 17. Computing environment 15, application 16 and/or data file 17 may be delivered via appliance 200 and/or the server 106.

Appliance 200 may accelerate delivery of all or a portion of computing environment 15 to a client 102, for example by the application delivery system 190. For example, appliance 200 may accelerate delivery of a streaming application and data file processable by the application from a data center to a remote user location by accelerating transport layer traffic between a client 102 and a server 106. Such acceleration may be provided by one or more techniques, such as: 1) transport layer connection pooling, 2) transport layer connection multiplexing, 3) transport control protocol buffering, 4) compression, 5) caching, or other techniques. Appliance 200 may also provide load balancing of servers 106 to process requests from clients 102, act as a proxy or access server to provide access to the one or more servers 106, provide security and/or act as a firewall between a client 102 and a server 106, provide Domain Name Service (DNS) resolution, provide one or more virtual servers or virtual internet protocol servers, and/or provide a secure virtual private network (VPN) connection from a client 102 to a server 106, such as a secure socket layer (SSL) VPN connection and/or provide encryption and decryption operations.

Application delivery management system 190 may deliver computing environment 15 to a user (e.g., client 102), remote or otherwise, based on authentication and authorization policies applied by policy engine 195. A remote user may obtain a computing environment and access to server stored applications and data files from any network-connected device (e.g., client 102). For example, appliance 200 may request an application and data file from server 106. In response to the request, application delivery system 190 and/or server 106 may deliver the application and data file to client 102, for example via an application stream to operate in computing environment 15 on client 102, or via a remote-display protocol or otherwise via remote-based or server-based computing. In an embodiment, application delivery system 190 may be implemented as any portion of the Citrix Workspace Suite™ by Citrix Systems, Inc., such as Citrix Virtual Apps and Desktops (formerly XenApp® and XenDesktop®).

Policy engine 195 may control and manage the access to, and execution and delivery of, applications. For example, policy engine 195 may determine the one or more applications a user or client 102 may access and/or how the application should be delivered to the user or client 102, such as a server-based computing, streaming or delivering the application locally to the client 120 for local execution.

For example, in operation, a client 102 may request execution of an application (e.g., application 16′) and application delivery system 190 of server 106 determines how to execute application 16′, for example based upon credentials received from client 102 and a user policy applied by policy engine 195 associated with the credentials. For example, application delivery system 190 may enable client 102 to receive application-output data generated by execution of the application on a server 106, may enable client 102 to execute the application locally after receiving the application from server 106, or may stream the application via network 104 to client 102. For example, in some embodiments, the application may be a server-based or a remote-based application executed on server 106 on behalf of client 102. Server 106 may display output to client 102 using a thin-client or remote-display protocol, such as the Independent Computing Architecture (ICA) protocol by Citrix Systems, Inc. of Fort Lauderdale, FL. The application may be any application related to real-time data communications, such as applications for streaming graphics, streaming video and/or audio or other data, delivery of remote desktops or workspaces or hosted services or applications, for example infrastructure as a service (IaaS), desktop as a service (DaaS), workspace as a service (WaaS), software as a service (SaaS) or platform as a service (PaaS).

One or more of servers 106 may include a performance monitoring service or agent 197. In some embodiments, a dedicated one or more servers 106 may be employed to perform performance monitoring. Performance monitoring may be performed using data collection, aggregation, analysis, management and reporting, for example by software, hardware or a combination thereof. Performance monitoring may include one or more agents for performing monitoring, measurement and data collection activities on clients 102 (e.g., client agent 120), servers 106 (e.g., agent 197) or an appliance 200 and/or 205 (agent not shown). In general, monitoring agents (e.g., 120 and/or 197) execute transparently (e.g., in the background) to any application and/or user of the device. In some embodiments, monitoring agent 197 includes any of the product embodiments referred to as Citrix Analytics or Citrix Application Delivery Management by Citrix Systems, Inc. of Fort Lauderdale, FL.

The monitoring agents 120 and 197 may monitor, measure, collect, and/or analyze data on a predetermined frequency, based upon an occurrence of given event(s), or in real time during operation of network environment 100. The monitoring agents may monitor resource consumption and/or performance of hardware, software, and/or communications resources of clients 102, networks 104, appliances 200 and/or 205, and/or servers 106. For example, network connections such as a transport layer connection, network latency, bandwidth utilization, end-user response times, application usage and performance, session connections to an application, cache usage, memory usage, processor usage, storage usage, database transactions, client and/or server utilization, active users, duration of user activity, application crashes, errors, or hangs, the time required to log-in to an application, a server, or the application delivery system, and/or other performance conditions and metrics may be monitored.

The monitoring agents 120 and 197 may provide application performance management for application delivery system 190. For example, based upon one or more monitored performance conditions or metrics, application delivery system 190 may be dynamically adjusted, for example periodically or in real-time, to optimize application delivery by servers 106 to clients 102 based upon network environment performance and conditions.

In described embodiments, clients 102, servers 106, and appliances 200 and 205 may be deployed as and/or executed on any type and form of computing device, such as any desktop computer, laptop computer, or mobile device capable of communication over at least one network and performing the operations described herein. For example, clients 102, servers 106 and/or appliances 200 and 205 may each correspond to one computer, a plurality of computers, or a network of distributed computers such as computer 101 shown in FIG. 1C.

As shown in FIG. 1C, computer 101 may include one or more processors 103, volatile memory 122 (e.g., RAM), non-volatile memory 128 (e.g., one or more hard disk drives (HDDs) or other magnetic or optical storage media, one or more solid state drives (SSDs) such as a flash drive or other solid state storage media, one or more hybrid magnetic and solid state drives, and/or one or more virtual storage volumes, such as a cloud storage, or a combination of such physical storage volumes and virtual storage volumes or arrays thereof), user interface (UI) 123, one or more communications interfaces 118, and communication bus 150. User interface 123 may include graphical user interface (GUI) 124 (e.g., a touchscreen, a display, etc.) and one or more input/output (I/O) devices 126 (e.g., a mouse, a keyboard, etc.). Non-volatile memory 128 stores operating system 115, one or more applications 116, and data 117 such that, for example, computer instructions of operating system 115 and/or applications 116 are executed by processor(s) 103 out of volatile memory 122. Data may be entered using an input device of GUI 124 or received from I/O device(s) 126. Various elements of computer 101 may communicate via communication bus 150. Computer 101 as shown in FIG. 1C is shown merely as an example, as clients 102, servers 106 and/or appliances 200 and 205 may be implemented by any computing or processing environment and with any type of machine or set of machines that may have suitable hardware and/or software capable of operating as described herein.

Processor(s) 103 may be implemented by one or more programmable processors executing one or more computer programs to perform the functions of the system. As used herein, the term “processor” describes an electronic circuit that performs a function, an operation, or a sequence of operations. The function, operation, or sequence of operations may be hard coded into the electronic circuit or soft coded by way of instructions held in a memory device. A “processor” may perform the function, operation, or sequence of operations using digital values or using analog signals. In some embodiments, the “processor” can be embodied in one or more application specific integrated circuits (ASICs), microprocessors, digital signal processors, microcontrollers, field programmable gate arrays (FPGAs), programmable logic arrays (PLAs), multi-core processors, or general-purpose computers with associated memory. The “processor” may be analog, digital or mixed-signal. In some embodiments, the “processor” may be one or more physical processors or one or more “virtual” (e.g., remotely located or “cloud”) processors.

Communications interfaces 118 may include one or more interfaces to enable computer 101 to access a computer network such as a LAN, a WAN, or the Internet through a variety of wired and/or wireless or cellular connections.

In described embodiments, a first computing device 101 may execute an application on behalf of a user of a client computing device (e.g., a client 102), may execute a virtual machine, which provides an execution session within which applications execute on behalf of a user or a client computing device (e.g., a client 102), such as a hosted desktop session, may execute a terminal services session to provide a hosted desktop environment, or may provide access to a computing environment including one or more of: one or more applications, one or more desktop applications, and one or more desktop sessions in which one or more applications may execute.

Additional details of the implementation and operation of network environment 100, clients 102, servers 106, and appliances 200 and 205 may be as described in U.S. Pat. No. 9,538,345, issued Jan. 3, 2017 to Citrix Systems, Inc. of Fort Lauderdale, FL, the teachings of which are hereby incorporated herein by reference.

Referring to FIG. 1D, a computing environment 160 is depicted. Computing environment 160 may generally be considered implemented as a cloud computing environment, an on-premises (“on-prem”) computing environment, or a hybrid computing environment including one or more on-prem computing environments and one or more cloud computing environments. When implemented as a cloud computing environment, also referred as a cloud environment, cloud computing or cloud network, computing environment 160 can provide the delivery of shared services (e.g., computer services) and shared resources (e.g., computer resources) to multiple users. For example, the computing environment 160 can include an environment or system for providing or delivering access to a plurality of shared services and resources to a plurality of users through the internet. The shared resources and services can include, but not limited to, networks, network bandwidth, servers 195, processing, memory, storage, applications, virtual machines, databases, software, hardware, analytics, and intelligence.

In embodiments, the computing environment 160 may provide client 165 with one or more resources provided by a network environment. The computing environment 165 may include one or more clients 165a-165n, in communication with a cloud 175 over one or more networks 170A, 170B. Clients 165 may include, e.g., thick clients, thin clients, and zero clients. The cloud 175 may include back end platforms, e.g., servers 195, storage, server farms or data centers. The clients 165 can be the same as or substantially similar to computer 100 of FIG. 1C.

The users or clients 165 can correspond to a single organization or multiple organizations. For example, the computing environment 160 can include a private cloud serving a single organization (e.g., enterprise cloud). The computing environment 160 can include a community cloud or public cloud serving multiple organizations. In embodiments, the computing environment 160 can include a hybrid cloud that is a combination of a public cloud and a private cloud. For example, the cloud 175 may be public, private, or hybrid. Public clouds 175 may include public servers 195 that are maintained by third parties to the clients 165 or the owners of the clients 165. The servers 195 may be located off-site in remote geographical locations as disclosed above or otherwise. Public clouds 175 may be connected to the servers 195 over a public network 170. Private clouds 175 may include private servers 195 that are physically maintained by clients 165 or owners of clients 165. Private clouds 175 may be connected to the servers 195 over a private network 170. Hybrid clouds 175 may include both the private and public networks 170A, 170B and servers 195.

The cloud 175 may include back end platforms, e.g., servers 195, storage, server farms or data centers. For example, the cloud 175 can include or correspond to a server 195 or system remote from one or more clients 165 to provide third party control over a pool of shared services and resources. The computing environment 160 can provide resource pooling to serve multiple users via clients 165 through a multi-tenant environment or multi-tenant model with different physical and virtual resources dynamically assigned and reassigned responsive to different demands within the respective environment. The multi-tenant environment can include a system or architecture that can provide a single instance of software, an application or a software application to serve multiple users. In embodiments, the computing environment 160 can provide on-demand self-service to unilaterally provision computing capabilities (e.g., server time, network storage) across a network for multiple clients 165. The computing environment 160 can provide an elasticity to dynamically scale out or scale in responsive to different demands from one or more clients 165. In some embodiments, the computing environment 160 can include or provide monitoring services to monitor, control and/or generate reports corresponding to the provided shared services and resources.

In some embodiments, the computing environment 160 can include and provide different types of cloud computing services. For example, the computing environment 160 can include Infrastructure as a service (IaaS). The computing environment 160 can include Platform as a service (PaaS). The computing environment 160 can include server-less computing. The computing environment 160 can include Software as a service (SaaS). For example, the cloud 175 may also include a cloud based delivery, e.g. Software as a Service (SaaS) 180, Platform as a Service (PaaS) 185, and Infrastructure as a Service (IaaS) 190. IaaS may refer to a user renting the use of infrastructure resources that are needed during a specified time period. IaaS providers may offer storage, networking, servers or virtualization resources from large pools, allowing the users to quickly scale up by accessing more resources as needed. Examples of IaaS include AMAZON WEB SERVICES provided by Amazon.com, Inc., of Seattle, Washington, RACKSPACE CLOUD provided by Rackspace US, Inc., of San Antonio, Texas, Google Compute Engine provided by Google Inc. of Mountain View, California, or RIGHTSCALE provided by RightScale, Inc., of Santa Barbara, California. PaaS providers may offer functionality provided by IaaS, including, e.g., storage, networking, servers or virtualization, as well as additional resources such as, e.g., the operating system, middleware, or runtime resources. Examples of PaaS include WINDOWS AZURE provided by Microsoft Corporation of Redmond, Washington, Google App Engine provided by Google Inc., and HEROKU provided by Heroku, Inc. of San Francisco, California. SaaS providers may offer the resources that PaaS provides, including storage, networking, servers, virtualization, operating system, middleware, or runtime resources. In some embodiments, SaaS providers may offer additional resources including, e.g., data and application resources. Examples of SaaS include GOOGLE APPS provided by Google Inc., SALESFORCE provided by Salesforce.com Inc. of San Francisco, California, or OFFICE 365 provided by Microsoft Corporation. Examples of SaaS may also include data storage providers, e.g. DROPBOX provided by Dropbox, Inc. of San Francisco, California, Microsoft SKYDRIVE provided by Microsoft Corporation, Google Drive provided by Google Inc., or Apple ICLOUD provided by Apple Inc. of Cupertino, California.

Clients 165 may access IaaS resources with one or more IaaS standards, including, e.g., Amazon Elastic Compute Cloud (EC2), Open Cloud Computing Interface (OCCI), Cloud Infrastructure Management Interface (CIMI), or OpenStack standards. Some IaaS standards may allow clients access to resources over HTTP, and may use Representational State Transfer (REST) protocol or Simple Object Access Protocol (SOAP). Clients 165 may access PaaS resources with different PaaS interfaces. Some PaaS interfaces use HTTP packages, standard Java APIs, JavaMail API, Java Data Objects (JDO), Java Persistence API (JPA), Python APIs, web integration APIs for different programming languages including, e.g., Rack for Ruby, WSGI for Python, or PSGI for Perl, or other APIs that may be built on REST, HTTP, XML, or other protocols. Clients 165 may access SaaS resources through the use of web-based user interfaces, provided by a web browser (e.g. GOOGLE CHROME, Microsoft INTERNET EXPLORER, or Mozilla Firefox provided by Mozilla Foundation of Mountain View, California). Clients 165 may also access SaaS resources through smartphone or tablet applications, including, e.g., Salesforce Sales Cloud, or Google Drive app. Clients 165 may also access SaaS resources through the client operating system, including, e.g., Windows file system for DROPBOX.

In some embodiments, access to IaaS, PaaS, or SaaS resources may be authenticated. For example, a server or authentication server may authenticate a user via security certificates, HTTPS, or API keys. API keys may include various encryption standards such as, e.g., Advanced Encryption Standard (AES). Data resources may be sent over Transport Layer Security (TLS) or Secure Sockets Layer (SSL).

### B. Appliance Architecture

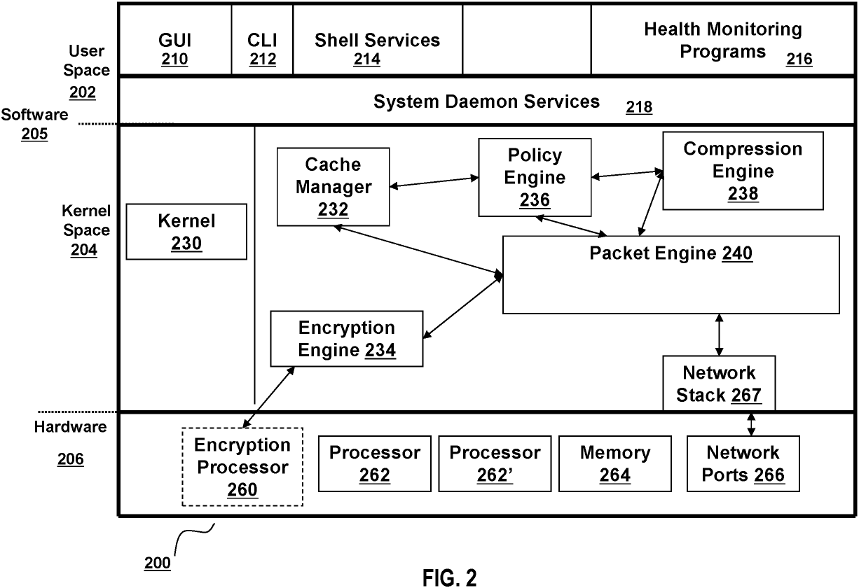

FIG. 2 shows an example embodiment of appliance 200. As described herein, appliance 200 may be implemented as a server, gateway, router, switch, bridge or other type of computing or network device. As shown in FIG. 2, an embodiment of appliance 200 may include a hardware layer 206 and a software layer 205 divided into a user space 202 and a kernel space 204. Hardware layer 206 provides the hardware elements upon which programs and services within kernel space 204 and user space 202 are executed and allow programs and services within kernel space 204 and user space 202 to communicate data both internally and externally with respect to appliance 200. As shown in FIG. 2, hardware layer 206 may include one or more processing units 262 for executing software programs and services, memory 264 for storing software and data, network ports 266 for transmitting and receiving data over a network, and encryption processor 260 for encrypting and decrypting data such as in relation to Secure Socket Layer (SSL) or Transport Layer Security (TLS) processing of data transmitted and received over the network.

An operating system of appliance 200 allocates, manages, or otherwise segregates the available system memory into kernel space 204 and user space 202. Kernel space 204 is reserved for running kernel 230, including any device drivers, kernel extensions or other kernel related software. As known to those skilled in the art, kernel 230 is the core of the operating system, and provides access, control, and management of resources and hardware-related elements of application 104. Kernel space 204 may also include a number of network services or processes working in conjunction with cache manager 232.

Appliance 200 may include one or more network stacks 267, such as a TCP/IP based stack, for communicating with client(s) 102, server(s) 106, network(s) 104, and/or other appliances 200 or 205. For example, appliance 200 may establish and/or terminate one or more transport layer connections between clients 102 and servers 106. Each network stack 267 may include a buffer 243 for queuing one or more network packets for transmission by appliance 200.

Kernel space 204 may include cache manager 232, packet engine 240, encryption engine 234, policy engine 236 and compression engine 238. In other words, one or more of processes 232, 240, 234, 236 and 238 run in the core address space of the operating system of appliance 200, which may reduce the number of data transactions to and from the memory and/or context switches between kernel mode and user mode, for example since data obtained in kernel mode may not need to be passed or copied to a user process, thread or user level data structure.

Cache manager 232 may duplicate original data stored elsewhere or data previously computed, generated or transmitted to reducing the access time of the data. In some embodiments, the cache memory may be a data object in memory 264 of appliance 200, or may be a physical memory having a faster access time than memory 264.

Policy engine 236 may include a statistical engine or other configuration mechanism to allow a user to identify, specify, define or configure a caching policy and access, control and management of objects, data or content being cached by appliance 200, and define or configure security, network traffic, network access, compression or other functions performed by appliance 200.

Encryption engine 234 may process any security related protocol, such as SSL or TLS. For example, encryption engine 234 may encrypt and decrypt network packets, or any portion thereof, communicated via appliance 200, may setup or establish SSL, TLS or other secure connections, for example between client 102, server 106, and/or other appliances 200 or 205. In some embodiments, encryption engine 234 may use a tunneling protocol to provide a VPN between a client 102 and a server 106. In some embodiments, encryption engine 234 is in communication with encryption processor 260. Compression engine 238 compresses network packets bi-directionally between clients 102 and servers 106 and/or between one or more appliances 200.

Packet engine 240 may manage kernel-level processing of packets received and transmitted by appliance 200 via network stacks 267 to send and receive network packets via network ports 266. Packet engine 240 may operate in conjunction with encryption engine 234, cache manager 232, policy engine 236 and compression engine 238, for example to perform encryption/decryption, traffic management such as request-level content switching and request-level cache redirection, and compression and decompression of data.

User space 202 is a memory area or portion of the operating system used by user mode applications or programs otherwise running in user mode. A user mode application may not access kernel space 204 directly and uses service calls in order to access kernel services. User space 202 may include graphical user interface (GUI) 210, a command line interface (CLI) 212, shell services 214, health monitor 216, and daemon services 218. GUI 210 and CLI 212 enable a system administrator or other user to interact with and control the operation of appliance 200, such as via the operating system of appliance 200. Shell services 214 include the programs, services, tasks, processes or executable instructions to support interaction with appliance 200 by a user via the GUI 210 and/or CLI 212.

Health monitor 216 monitors, checks, reports and ensures that network systems are functioning properly and that users are receiving requested content over a network, for example by monitoring activity of appliance 200. In some embodiments, health monitor 216 intercepts and inspects any network traffic passed via appliance 200. For example, health monitor 216 may interface with one or more of encryption engine 234, cache manager 232, policy engine 236, compression engine 238, packet engine 240, daemon services 218, and shell services 214 to determine a state, status, operating condition, or health of any portion of the appliance 200. Further, health monitor 216 may determine if a program, process, service or task is active and currently running, check status, error or history logs provided by any program, process, service or task to determine any condition, status or error with any portion of appliance 200. Additionally, health monitor 216 may measure and monitor the performance of any application, program, process, service, task or thread executing on appliance 200.

Daemon services 218 are programs that run continuously or in the background and handle periodic service requests received by appliance 200. In some embodiments, a daemon service may forward the requests to other programs or processes, such as another daemon service 218 as appropriate.

As described herein, appliance 200 may relieve servers 106 of much of the processing load caused by repeatedly opening and closing transport layer connections to clients 102 by opening one or more transport layer connections with each server 106 and maintaining these connections to allow repeated data accesses by clients via the Internet (e.g., “connection pooling”). To perform connection pooling, appliance 200 may translate or multiplex communications by modifying sequence numbers and acknowledgment numbers at the transport layer protocol level (e.g., “connection multiplexing”). Appliance 200 may also provide switching or load balancing for communications between the client 102 and server 106.

As described herein, each client 102 may include client agent 120 for establishing and exchanging communications with appliance 200 and/or server 106 via a network 104. Client 102 may have installed and/or execute one or more applications that are in communication with network 104. Client agent 120 may intercept network communications from a network stack used by the one or more applications. For example, client agent 120 may intercept a network communication at any point in a network stack and redirect the network communication to a destination desired, managed or controlled by client agent 120, for example to intercept and redirect a transport layer connection to an IP address and port controlled or managed by client agent 120. Thus, client agent 120 may transparently intercept any protocol layer below the transport layer, such as the network layer, and any protocol layer above the transport layer, such as the session, presentation or application layers. Client agent 120 can interface with the transport layer to secure, optimize, accelerate, route or load-balance any communications provided via any protocol carried by the transport layer.

In some embodiments, client agent 120 is implemented as an Independent Computing Architecture (ICA) client developed by Citrix Systems, Inc. of Fort Lauderdale, FL. Client agent 120 may perform acceleration, streaming, monitoring, and/or other operations. For example, client agent 120 may accelerate streaming an application from a server 106 to a client 102. Client agent 120 may also perform end-point detection/scanning and collect end-point information about client 102 for appliance 200 and/or server 106. Appliance 200 and/or server 106 may use the collected information to determine and provide access, authentication and authorization control of the client’s connection to network 104. For example, client agent 120 may identify and determine one or more client-side attributes, such as: the operating system and/or a version of an operating system, a service pack of the operating system, a running service, a running process, a file, presence or versions of various applications of the client, such as antivirus, firewall, security, and/or other software.

Additional details of the implementation and operation of appliance 200 may be as described in U.S. Pat. No. 9,538,345, issued Jan. 3, 2017 to Citrix Systems, Inc. of Fort Lauderdale, FL, the teachings of which are hereby incorporated herein by reference.

### C. Systems and Methods for Accessing and Managing Resources

The present disclosure is directed towards systems and methods for accessing and/or provisioning resources. For instance, the systems and methods described herein can provide a novel approach for efficiently managing, provisioning and/or accessing resources (e.g., platform as a services (PaaS) resources) via a computing device and/or client device though a user interface (e.g., a graphical user interface (GUI)), according to a relationship between a user of a client device (e.g., a smartphone, a laptop, a tablet device, a desktop computer of a user, and/or a client supporting HTTP/HTTPS) and the resource(s) (e.g., using a role-based access control (RBAC) approach). In certain embodiments, an administrative entity (e.g., an administrator and/or other entities, such as an administrative program) can provision and/or assign the resource (e.g., an active resource and/or a non-static resource, such as a database and/or a virtual disk) to the user of the client devices via a computing device. Responsive to said provisioning and/or assignments, the user may access, use, and/or utilize the resource(s) (e.g., through a user interface, with use of credentials) via a client device, without the user having to separately or manually configure and/or establish a link/relationship between the corresponding resource and the user interface. As such, embodiments of the present disclosure can reduce and/or eliminate the separate configuration, access or activation of user interfaces (e.g., management consoles and/or other console applications) to manage delivery and/or provisioning of resources (e.g., PaaS resources and/or other resources) to one or more users. In addition, the systems and methods presented herein can support and/or enable power management and/or provisioning of resources by using a single activation or selection (e.g., a click) in a user interface (e.g., a GUI).

In certain embodiments, the systems and methods presented herein may provide access to one or more resources (e.g., compute resources) via a client application (e.g., Citrix Workspace Suite™ by Citrix Systems, Inc.), responsive to a provisioning of the resources via a console (e.g., Citrix administrator console and/or other consoles). In one example, one or more developers may use a resource, such as a container, as a portable environment for development (e.g., for developing the first resource). Embodiments of the present disclosure may allow the developer(s) to continue the development of resources via the client application, while an administrative entity can deliver and/or manage the resources (e.g., to one or more users) via the console.

In some embodiments of the present solution, authenticated users may perform one or more actions on the resources according to (or based on) role based access control (RBAC) mechanisms. For example, authenticated users may perform a subset of actions on the resources based on the role, responsibility, title, permissions and/or position of the user within an enterprise and/or organization. As such, RBAC can restrict the access and/or usage of the resource(s) to authenticated users based on the role(s) and/or privileges of the user within the enterprise/organization.

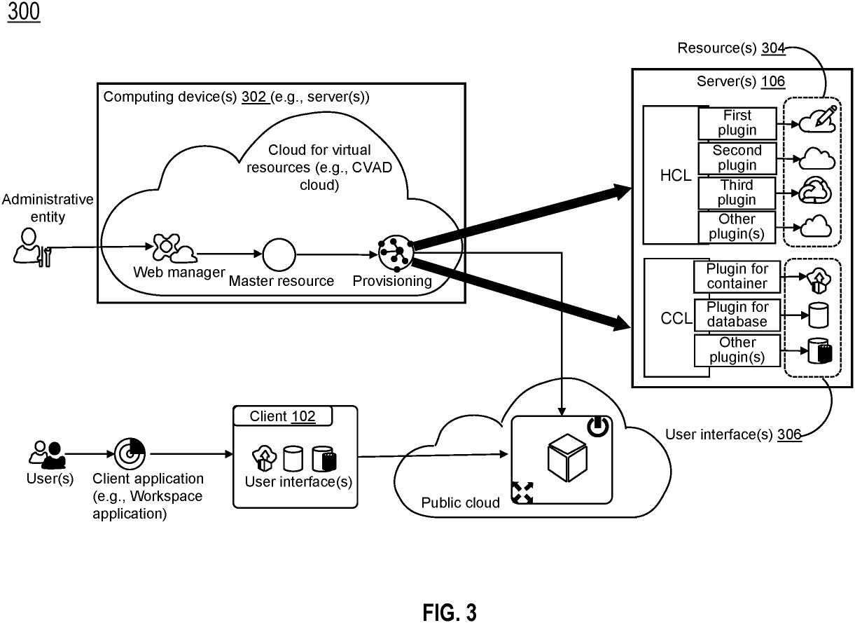

In view of the above discussion regarding accessing, using, provisioning, and/or managing resources, a process and/or system for performing said accessing, using, provisioning, and/or managing may be beneficial, as further explained in the following passages. Referring to FIG. 3, depicted is a block diagram of one example embodiment of a system 300 for accessing, using, and/or provisioning resources based on a relationship between a user of a client device and the resources, and/or credentials (e.g., domain-based credentials). The system 300 may include one or more client devices 102 of a user (sometimes referred to as clients 102), one or more computing devices 302, one or more servers 106 and/or other components. The computing device 302 can maintain or have access to a cloud (e.g., servers) for hosting virtual resources, such as a cloud for hosting virtual applications (apps) and/or other services (e.g., Desktop services). The server(s) 106 can include or maintain or have access to one or more resources 304 (e.g., an active, non-static or backend resource, such as a database server, container or a virtual disk). One or more users can have access to the resources 304 via the client devices 102 (e.g., client 102). The client(s) 102 can provide a user interface 306 (e.g., a secure shell or SSH console, another client for accessing databases, and/or other frontend resources) to the user(s) through which to access the resource(s) 304 (e.g., a container, a database, and/or other resources). In one example, a plugin for the client device 102 (e.g., plugin for container, plugin for database, and/or other plugins) can be used to provision the user interface(s) 306 to the client 102. In certain embodiments, the user(s) may access and/or use the resource(s) 304 (e.g. through the user interface(s) 306) via a public cloud (such as public cloud 175).

Each of the above-mentioned elements or entities is implemented in hardware, or a combination of hardware and software, in one or more embodiments. Each component of the system 300 may be implemented using hardware or a combination of hardware or software detailed above in connection with FIG. 1C. For instance, each of these elements or entities can include any application, program, library, script, task, service, process or any type and form of executable instructions executing on hardware of a client device 102, a server 106 and/or a network device 200 in connection with FIGS. 1B-1C, for instance. The hardware includes circuitry such as one or more processors in one or more embodiments.

The system 300 may include one or more servers 106. One or more of the server(s) 106 (e.g., a back-end server supporting HTTPS messages or transactions, and/or other servers 106) may be configured and/or designed to host one or more resources 304 and/or other services (e.g., application resources, as a web application, SaaS application, PaaS application, and/or a remote-hosted network application). The server 106 may be configured and/or designed to provision and/or execute the one or more resources 304 and/or services (or provision user interfaces 306 through which to access the resource(s) 304 and/or service(s)) to one or more clients 102 (e.g., one or more mobile devices, tablets, desktops, and/or other clients 102) of a consumer or other entity (e.g., an organization or a user of the client device 102) via one or more networks 104. For example, the client 102 may establish one or more sessions or connections (e.g., secured or otherwise, such as a SSL virtual private network connection) with the server(s) 106 to access a service/resource (e.g., through a user interface 306), such as an application resource (e.g., PaaS resource and/or other resources). In another example, the server(s) 106 may receive/obtain a request (e.g., such as a HTTP request) from at least one computing device 302 and/or other devices (e.g., client devices 102) to access, use and/or provision one or more resources 304 (or establish the connections to access the one or more resources 304).

In some embodiments, a first subset of one or more servers 106 can execute, provide, provision, and/or host one or more resources 304 and/or one or more plugins for provisioning resources 304. In certain embodiments, a second subset of the one or more servers 106 may execute, provide, provision, and/or host one or more user interfaces 306 (and/or one or more plugins for provisioning user interfaces 306) through which to access the one or more resources 304. In one example, the first subset of the one or more servers 106 may include or correspond to the second subset of the one or more servers 106. In certain embodiments, the first subset of the one or more servers 106 may be separate, distinct, and/or different from the second subset of the one or more servers 106.

To provide a service/resource 304, the server(s) 106 may execute, provide, provision, and/or host one or more network application(s). In some embodiments, a service/resource 304 may be referred to interchangeably with an application, application resource or network application. A network application can for instance include a remote-hosted application, a remote-hosted desktop, a web application or a software-as-a-service (SaaS) application. A remote-hosted desktop may be a virtual desktop hosted on the server 106 which is accessed by or remotely provisioned to a client 102. In some embodiments, the delivery of a remote-hosted desktop may be via a session and/or connection based on High-Definition User Experience (HDX) or Independent Computing Architecture (ICA) display remoting protocol, or Remote Desktop Protocol (RDP). A remote-hosted application may include/correspond to an application service that can be delivered via a HDX-based, ICA-based, RDP-based, etc., session and/or connection. In some embodiments, a remote-hosted application may be an application which is installed on/in the remote-hosted desktop environment and is therefore accessible within the remote-hosted desktop. A SaaS application can be a centrally-hosted application which is typically accessible on a subscription basis. In some embodiments, the SaaS applications may include web-based applications. In other embodiments, the SaaS applications may correspond to remote-hosted applications and, therefore, can be delivered in HDX/ICA/RDP -based sessions and/or connections. SaaS applications and/or web applications may include for instance salesforce.com, SAP, Microsoft Office 365, Dropbox or Gmail service, Amazon web services, and so on.

In some embodiments, the server(s) 106 can be part of a cloud or datacenter for instance. In some embodiments, the server(s) 106 can include or correspond to the computing device 302. The server(s) 106 may include any embodiment of volatile memory 122 or non-volatile memory 128 (discussed in FIG. 1C for example) which may store files, data and/or content of the service. The server(s) 106 may communicate with other various components of the system 300 in FIG. 3 via a communications interface 118 for instance. Hence, the server(s) 106 may be similar in some aspects to the computer 101 described with reference to FIG. 1C.

The system 300 may include one or more clients 102 (or client devices 102), such as one or more mobile devices, tablets, laptops, computers, and/or other clients 102. The client(s) 102 may include or correspond to one or more devices of a consumer of a resource 304, such as a user. In one example, if the consumer is an individual or user, the client device(s) 102 may comprise a smartphone, a laptop (e.g., at home), a tablet device, and a desktop computer (e.g., at work), that the user may use to access an application resource (e.g., Dropbox service) and/or other resources at various times and/or locations for instance. In an example where the consumer is an organization, such as an enterprise, the consumer can extend over a number of users (e.g., management persons, staff members, IT administrators, and so on) and their associated client(s) 102 or devices (e.g., corporate-issued device, personally-owned devices, and/or registered/approved devices (e.g., in a BYOD program)). Any number of the users may access a service/resource 304 (e.g., salesforce.com, SAP, Microsoft Office 365) from a service/resource provider, via a corporate account for the service/resource 304 for instance. In some embodiments, the client device(s) 102 may interact with the server(s) 106 directly, or indirectly via a computing device 302 and/or other devices (e.g., devices intermediary between the client device(s) 102 and the server(s) 106).

In certain embodiments, one or more users of the client device(s) 102 may have a relationship (or be associated with) with one or more resources 304 (e.g., resources executable on one or more servers 106), that may be predefined/preconfigured/pre-determined by an administrative entity. For instance, a user of the client(s) 102 may be an authorized user of a resource 304 (e.g., according to a user group of the user(s)). In another example, the user of the client(s) 102 can be an owner, a contributor, an administrator, and/or an operator of the resource 304. A database (e.g., a mapping database) can store and/or maintain relationship information of the user(s) of the client device(s) 102 and the resource(s) 304. In certain embodiments, an administrative entity (e.g. an administrator) of the computing device 302 may define and/or preconfigure said relationship information in the database (e.g., a mapping database). For instance, the administrative entity may preconfigure a role of a user within an organization in the database, wherein the role may describe, define and/or specify (or be associated with) the relationship between the user and the resource 304. In another example, the administrative entity may define, preconfigure and/or store a user group of the user in the database. Said user group may comprise one or more users (including the user of interest), wherein the one or more users can share the same access and/or privileges to the resource 304. As such, the user group (e.g., stored in the database) may describe, specify and/or identify the relationship between the user and the resource 304. In certain embodiments, the administrative entity can preconfigure and/or define the relationship in the database via a console (e.g., an administrator console).

In some embodiments, the system 300 may include one or more computing devices 302. The computing device(s) 302 may be located at any one of various points or in any of various communication paths, for example between two networks 104, within a computing and/or network environment 100. In other embodiments, the computing device(s) 302 may be located on a network 104. In some embodiments, the computing device(s) 302 may act as a proxy to provide access to the one or more servers 106, provide security and/or act as a firewall between the client device(s) 102 and the server(s) 106. In certain embodiments, the computing device(s) 302 may include or correspond to the one or more servers 106. In some embodiments, the computing device(s) 302 can receive and/or obtain a request (e.g., a first request) to access a resource 304 (e.g., a container, a database, and/or other resources). For example, the computing device(s) 302 may receive the request to access/use the resource 304 from a user via a client device 102 and/or a client application (e.g., Citrix Workspace Suite™ by Citrix Systems, Inc.). In certain embodiments, the resource 304 may include data to provision the resource 304 to one or more client devices 102 (e.g., clients 102 of a user). For example, the resource(s) 304 (e.g., PaaS resource) may include or correspond to one or more plugins (e.g., first plugin, second plugin, third plugin, and/or other plugins) that are hosted, maintained and/or provisioned in one or more servers 106. A corresponding plugin can be used to provision a particular resource 304 to one or more client devices 102 (e.g., for access and/or usage by the user of the client device 102).

In some embodiments, the computing device 302 may be configured and/or designed to access, use, manage and/or provision one or more resources 304 of the server 106 according to credentials (e.g., first credentials and/or second credentials). In one example, the computing device 302 may determine that the user and the resource 304 have a relationship (e.g., the user is an authorized user of the resource 304). The relationship between the user and the resource 304 can enable provision of the resource 304 to the client device 102. For instance, the computing device 302 may determine that the user is an authorized user, administrator and/or developer of the resource 304 (or have other authorized relationships with the resource 304). Given the nature of said relationship(s) between the user and the resource 304 (e.g., an authorized relationship), the existence of the relationship may enable the provision of the resource 304 to the client device 102 of the user (e.g., for usage by the user). If, on the other hand, the computing device 302 determines that the user and the resource 304 do not have a (pre-established or existing) relationship, the lack of a relationship between the user and the resource 304 may fail to enable the provision of the resource 304 to the client 102. In certain embodiments, the resource 304 may be provisioned according to (e.g., with use of) first credentials (e.g., a password, an identifier, a personal identification number, and/or other types of credentials). In certain embodiments, the first credentials may allow the user to access and/or use the resource 304 via the client device 102 (e.g., according to the relationship between the user and the resource 304). In some embodiments, the administrative entity may define and/or configure the first credentials as described above.

In certain embodiments, the computing device 302 may be configured to initiate and/or trigger a second request. For example, the computing device 302 may initiate a second request to provide a user interface 306 (e.g., a frontend resource) through which to access a corresponding resource 304. In certain embodiments, the computing device 302 can initiate the second request by causing the client device 102 to send and/or transmit the second request. In one example, the computing device 302 and/or the client device 102 may send and/or transmit the second request (responsive to initiating the second request) to the server(s) 106. Responsive to receiving the second request, the server(s) 106 may provide the user interface 306 to the user via the client device 102. For example, in response to receiving the second request, the server(s) 106 may use a plugin (e.g., a plugin for a container, a plugin for a database, and/or other plugins) to provision the corresponding user interface 306 (e.g., associated with the resource 304) to the client device 102. As such, once the server(s) provisions the user interface 306, the user may use and/or access the resource 304 through (e.g., via) the user interface 306 (e.g., a web console for accessing containers, a database client for accessing clients, and/or other types of user interfaces).

In certain embodiments, the computing device 302 may be configured to provide the user with access to the user interface 306 (e.g., via the client device 102). For instance, the computing device 302 may provide the user with access to the user interface 306 (e.g., to access and/or use the resource 304) responsive to authenticating the user (e.g., confirming whether the user is an authorized user of the client device 102). In one example, the computing device 302 may authenticate the user with use of second credentials (e.g., biometric features of the user, an identification number, a digital certificate, an authentication token, a password, a security question, a one-time password, and/or other types of credentials). In certain embodiments, the second credentials can be different, separate and/or distinct from the first credentials. For example, the first credentials can be used for accessing and/or provisioning the resource 304 to the client device 102, while the second credentials may be used for authenticating, validating and/or confirming the identity of the user of the client device 102.

In certain embodiments (e.g., in administration scenarios), a console (e.g., an administration console) may enable the selection of at least one resource 304 (e.g., PaaS resource, for instance as a resource for provisioning to one or more client devices 102). A resource (e.g., accessible via the computing device 302) may include or correspond to a container image and/or other types of resources. A customer and/or user may upload the container image to a registry (e.g., an image registry). In some embodiments, the resource may include or correspond to a database and/or a container. In certain embodiments, a hardware compatibility list (HCL) layer (and/or other layers) of the server(s) 106 may support and/or enable provisioning of resources 304 (e.g., the resource). For instance, the HCL layer can support and/or enable the provisioning of resources 304 via one or more plugins (e.g., first plugin, second plugin, third plugin, and/or other plugins). In some embodiments, a client compatible layer (CCL) of the server(s) 106 may include one or more plugins (e.g., plugin for a container, plugin for a database and/or other plugins). Individual plugins may correspond to (or be associated with) a particular resource 304 (e.g., one plugin for a specific PaaS resource). In certain embodiments, the plugin(s) of the CCL may be used to provision and/or provide (e.g., to client devices 102) a corresponding user interface 306 through which to access a particular resource 304. The user interface(s) 306 can be provisioned and/or provided to the client device(s) 102. In one example, a plugin for a container may provision/provide a web SSH console (and/or other example user interfaces) to access and/or use the container. In another example, a plugin for a database may provision/provide a database client (and/or other example user interfaces) to access and/or use a database.

In some embodiments, a service (e.g., an administration service) may store and/or maintain information of the resources 304, such as icons, addresses, user assignment information and/or other information for accessing/using the resources 304 (e.g., PaaS resources). In certain embodiments, the resources 304 (e.g., resources provisioned client device(s) 102) can be managed, used, provisioned, and/or accessed according to a particular mechanism of RBAC. In some embodiments, RBAC may use and/or consider the relationship between the user of the client 102 and the resource 304. For example, according to RBAC, access and/or usage of a resource 304 (e.g., by a user) can be allowed or restricted based on the relationship between the user of the client 102 and the resource 304. In some embodiments, a user can be authenticated (e.g., domain-based authentication), to provide the user with access to the user interface 306 (e.g. to access/use the resource 304). In certain embodiments, an administrative entity can provide, define and/or configure credentials (e.g., first credentials) for accessing a resource 304 via an administrating console. The credentials may be encrypted and/or stored in the database. In some embodiments, the administrative entity may configure, specify and/or define the relationship between the user of the client 102 and the resource 304. For example, the administrative entity may configure/store a mapping (e.g. a relationship) between the user and the resource 304 in a database.

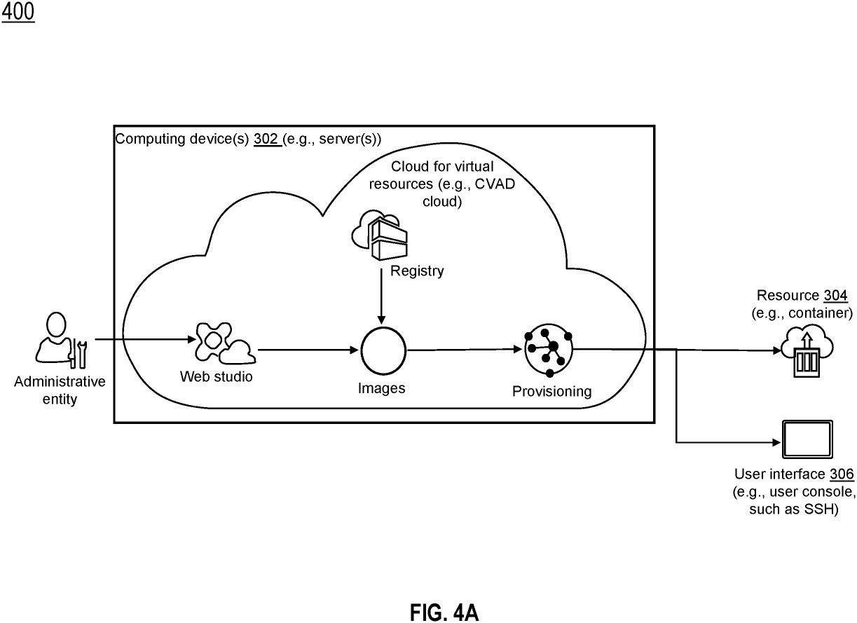

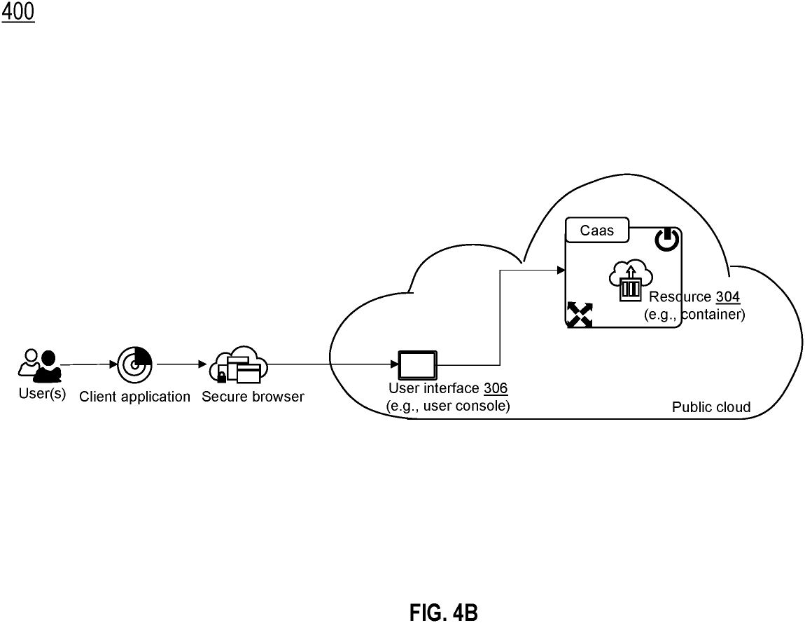

Referring now to FIGS. 4A-4B, depicted are block diagrams of example embodiments of a system 400 for accessing, using, and/or provisioning an example resource 304, such as a container. FIG. 4A depicts an administration scenario (e.g., an administrative entity configuring resources 304), while FIG. 4B describes a user scenario (e.g., a user accessing resources 304). In FIG. 4A, an administrative entity may create and/or configure images of a container (or other resources 304) via a service and/or platform of a computing device 302, such as web manager. The administrative entity may upload (e.g., via the computing device 302) the image of the container to a registry in advance (e.g., running as instances inside a public cloud). Another service and/or platform of the computing device 302 (e.g., a service for virtual resources, such as virtual applications and desktops) may provide, specify and/or indicate one or more container images. For instance, the another service can provide and/or specify a container image as a resource upon creation of a machine catalog. A container manager may be configured into one or more HCL plugins, implementing interfaces for provisioning an application programming interface (API) and/or integrating with the another service. A plugin for accessing the container (e.g., through a user interface 306 via the client 102) may be configured under the CCL. As such, the plugin may create a user interface 306 (e.g., a container client web SSH console) for accessing the resource 304 (e.g. the container instance). In certain embodiments, the resource 304 (e.g., container) and/or the user interface 306 (e.g., web console) may be provisioned. Information of the resource 304 (e.g., an icon, an address for the provisioned container, RBAC information, and/or other information) may be stored in a database. An access key may not be used to access the container (which may be based on a RBAC access mechanism), but can be used for accessing other resources such as a user interface or frontend resource (e.g., due to different mechanisms for access and/or authentication for different resources), in some embodiments.

In FIG. 4B, a user may access and/or view a list of resources (e.g., a list of provisioned containers) via a client application (e.g., Citrix Workspace), a client device 102 and/or a secure browser. The client application and/or client device 102 may provide and/or specify one or more icons of the listed resources, an address of the listed resources, one or more RBAC rules for the listed resources, and/or other information of the resources. Corresponding information (e.g., authentication credentials, an address of the listed resources, RBAC rules, and/or other information) may be used as parameters when launching and/or initiating the user interface 306 (e.g., a SSH application). A connection to the container (and/or other resources) may be established based on the parameters. As described above, an administrative entity can provision, manage, and/or assign resources 304 (e.g., containers) via a computing device 302, while users can access, use and/or leverage the resources 304 based on RBAC (e.g., based on a relationship between the user of the client device 302 and the resource 304).

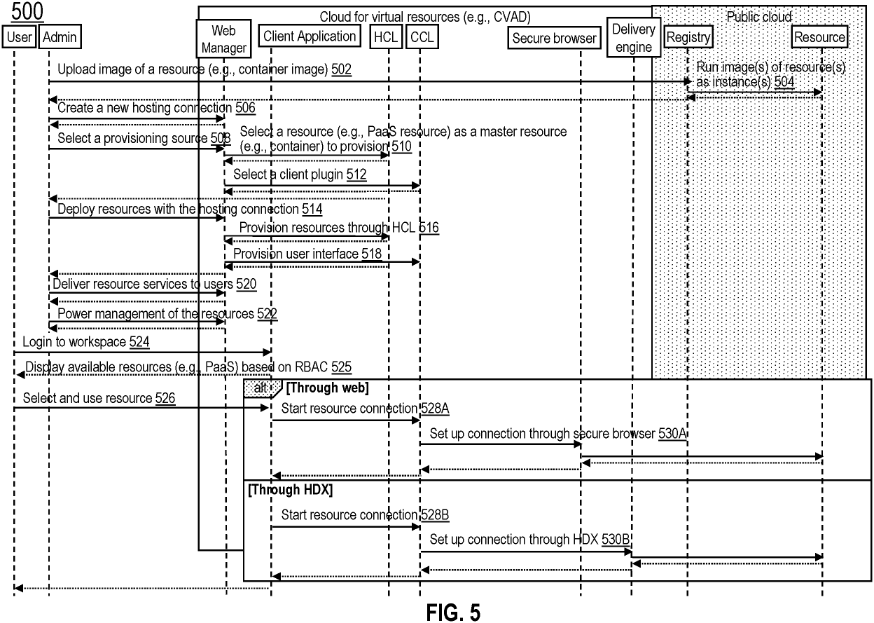

Referring now to FIG. 5, depicted is a diagram of an embodiment of a process 500 for accessing, using, and/or provisioning resources based on a relationship between a user of a client device 102 and the resources 304, and/or credentials. In accordance with process 500, the administrative entity (e.g., admin) may upload an image (e.g., a copy and/or a state of a computing system/environment and/or content/data) of a resource 304 (e.g., a container) to a registry (e.g., a container registry) (502). The registry (e.g., container registry) and/or resource (e.g., container services) may run the image of the resource 304 as an instance (504). In some embodiments, the administrative entity may create, establish and/or configure a hosting connection via a service and/or platform, such as web studio (506). The administrative entity may select and/or use at least one provisioning resource 304 as a resource (508). In certain embodiments, the administrative entity may select and/or use at least one resource 304 (e.g., PaaS resource) as a resource (for example, a container) (510). In some embodiments, the administrative entity may select and/or use a client plugin for the resource (e.g., a web SSH console) (512).

In certain embodiments, the administrative entity may deploy one or more resources 304 (e.g., one or more containers) using the hosting connection from step 506 (514). The administrative entity may specify and/or provide a count/amount of resources 304, a memory and/or other information via a machine catalog node of the service and/or platform (e.g. web manager). In some embodiments, at least one resource 304 (e.g. container) may be provisioned (e.g., by the computing device 302) through HCL, according to the resource of step 508 (516). In certain embodiments, a corresponding user interface 306 (e.g., a client Web SSH application) may be provisioned (e.g., by the computing device 302), for accessing the resource(s) 304 (518). Information of the relationship between the user of the client 102 and the provisioned resource 304 (and/or other information) can be stored in a database. In some embodiments, the administrative entity may provide and/or deliver the resource 304 (e.g., services of the resource 304) to one or more users via a delivery group node of web manager, for example (520). The administrative entity may manage and/or regulate the power consumption of the resources 304 (522).

In certain embodiments, a user may login to a client application (e.g., via a client device 102) (524). The client application (may display, provide and/or illustrate a list of available resources 304 (e.g. available for usage) to the user (525). In some embodiments, the user may select and/or use a resource 304 from the list of available resources 304 (526). Responsive to a selection of the resource 304, a computing device 302 (e.g., web manager of a computing device 302) may launch, establish and/or initiate a connection to the resource 304 via the CCL and/or a secure browser (528A and 530A). In some embodiments, the computing device 302 (e.g., web manager of a computing device 302) may launch, establish and/or initiate a connection to the resource 304 via a delivery engine (528B and 530B). Responsive to an establishment of the connection, the user may access and/or use the resource 304 through the user interface 306 (e.g., via the client device 102).

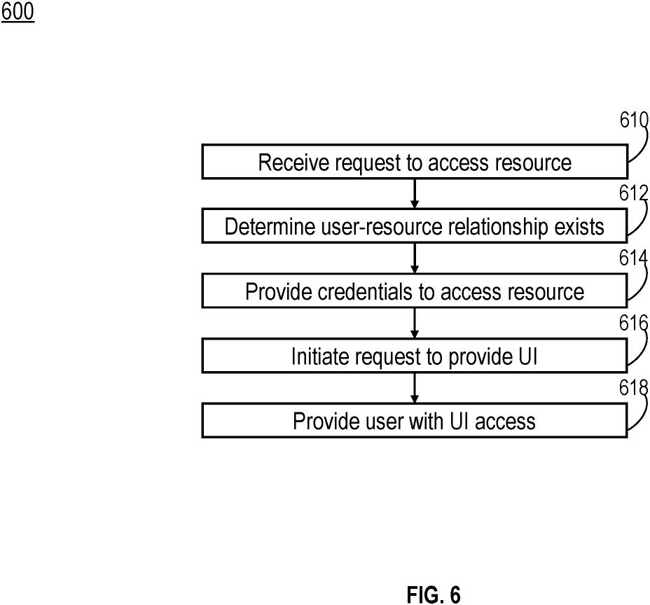

Referring to FIG. 6, depicted is a flow diagram 600 of one embodiment of a method for accessing, using, and/or provisioning resources based on a relationship between a user of a client device 102 and the resources 304, and/or credentials. The functionalities of the method may be implemented using, or performed by, the components detailed herein in connection with FIGS. 1-5. In brief overview, a computing device 302 may receive a request to access a resource 304 (610). The computing device 302 may determine a relationship exists between the user of a client device 102 and the resource 304 (612). The computing device 302 may provide credentials (e.g., first credentials) to access the resource 304 (614). The computing device 302 may initiate a request to provide a user interface (UI) (616). The computing device 302 may provide a user with access to the UI (618).

Referring now to operation (610), and in some embodiments, the computing device 302 (e.g., a server 106 and/or other devices) may receive and/or obtain a request (e.g., a first request) to access and/or use at least one resource 304 (e.g., an active, non-static or backend resource, such as a database server or a virtual disk). For example, the computing device 302 may receive a first request initiated by a user via a client device 102 (e.g., a mobile device). The first request may include or correspond to a request for accessing and/or using a container and/or database. In certain embodiments, the resource(s) 304 may be executable on one or more servers 106. In one example, the resource(s) 304 may execute on a first subset of the one or more servers 106. The user interface(s) 306 may execute on a second subset of the one or more servers 106. The first subset and the second subset can be different from each other. In certain embodiments, the resource(s) 304 and the user interface(s) 304 may execute on a same server 106 (or a same subset of servers 106). In some embodiments, the resource(s) 304 may include data to provision the resource(s) 304 to one or more client devices 102. For example, the resource(s) 304 (e.g., PaaS resource) may include or correspond to one or more plugins (e.g., first plugin, second plugin, third plugin, and/or other plugins) that are hosted, maintained and/or provisioned in one or more servers 106. A corresponding plugin may include and/or use data to provision a particular resource 304 to one or more client devices 102 (e.g., for access and/or usage by the user of the client device 102).

Referring now to operation (612), and in some embodiments, the computing device 302 may determine that a relationship between a user of a client device 102 and one or more resources 304 exists. For instance, a user of the client(s) 102 may be an authorized user of a resource 304 (e.g., according to a user group of the user(s)). In another example, the user of the client(s) 102 can be an owner, a contributor, an administrator, and/or an operator of the resource 304. In one example, the computing device 302 may determine that the user is an authorized user, administrator and/or developer of the resource 304 (or have other authorized relationships with the resource 304). Responsive to determining that the relationship exists (e.g. an authorized relationship between the user and the resource(s) 304), the computing device 302 may provide and/or access the first credentials to allow the user to access the resource(s) 304 (614). As such, the computing device 302 may use the first credentials to provide the user with access to the resource(s) 304. In certain embodiments, the relationship between the user and the resource(s) 304 can enable provision of the resource(s) 304 to one or more client devices 102. For example, if the user is an authorized user of the client device 102, the authorized relationship may enable the provision of the resource 304 to the client device 102 of the user (e.g., for usage by the user). If, on the other hand, the computing device 302 determines that the user and the resource 304 do not have a (pre-established or existing) relationship, the lack of a relationship between the user and the resource 304 may prevent (or fail to enable) the provision of the resource 304 to the client 102.

In certain embodiments, the relationship between a user of a client device 102 and one or more resources 304 can be preconfigured and/or defined (e.g., by an administrative entity) in a database. For example, the database may include, store and/or maintain a plurality of relationships and/or other information of the user and/or resource(s) 304. Each of the relationships can be between at least one user and at least one resource 304. In some embodiments, the at least one resource 304 may include the user interface 306. In certain embodiments, the relationship between the user and the resource 304 may include or correspond to a relationship between a group of users (including the user) and the resource 304 (e.g., a many-to-one mapping). In some embodiments, the relationship between the user and the resource 304 may include or correspond to a relationship between the user and a plurality of resources 304 (e.g., a one-to-many mapping). The plurality of resources 304 may include the resource 304.

In some embodiments, first credentials (e.g., a password, an identifier, a personal identification number, biometric features of the user, a digital certificate, an authentication token, a security question, a one-time password, and/or other types of credentials) may be used (e.g., by the computing device 302) to provision the resource(s) 304 to the client device(s) 102. For instance, the computing device 302 may determine whether the first credentials for provisioning the resource(s) 304 are stored and/or maintained in the database (or are otherwise accessible to the computing device 302). Responsive to determining the first credentials are stored (or otherwise available/accessible), the computing device 302 may use the first credentials to provision the resource(s) 304. In certain embodiments, an encrypted and/or encoded version of the first credentials can be stored in the database. In certain embodiments, an administrative entity of the computing device 302 (e.g. a program and/or an administrator) may define, establish, and/or configure the first credentials for provisioning the resource(s) 304. For example, the administrative entity may use an administrator console to provide and/or configure the first credentials in the database (or in other locations accessible to the computing device 302). In certain embodiments, the administrative entity may provide and/or configure the first credentials prior to usage of the resource(s) 304 by the user of the client device(s) 102.

In some embodiments, the first credentials may be configured for use in accordance with each of at least two relationships of a plurality of relationships (e.g., stored in a database). As such, the first credentials may be shared among a plurality of user-to-resource pairings, mappings and/or relationships. In one example, the same first credentials (e.g., for provisioning the resources 304) may be used for a first relationship (e.g., between a user and a first resource 304(1)) and a second relationship (e.g., between a same user and a second resource 304(2)). In another example, a first relationship between a first user and a resource 304, and a second relationship between a second user and a same resource 304, may use the same first credentials (e.g., for provisioning the resources 304).

Referring now to operation (616), and in some embodiments, the computing device 302 may initiate and/or launch a request to provide one or more user interfaces 306 corresponding to (or supporting/enabling access to) each resource 304. In one example, and responsive to determining the existence of the relationship between the user and the resource(s) 304, the computing device 302 may (automatically) initiate a second request. The second request may include or correspond to a request to provide (e.g., provide to the user via the client device 102) at least one user interface (UI) 306 through which to access the resource(s) 304. In some embodiments, the computing device 302 may initiate the second request by causing the client device(s) 102 to send the second request to one or more servers 103 hosting/maintaining the resource(s) 304. In another example, the computing device 302 may initiate the second request by sending and/or transmitting the second request to the server(s) 106. In one example, the computing device 302 may determine that a relationship exists between a resource 304 and the user interface 306. For instance, the computing device 302 may determine that a resource 304 has a corresponding user interface 306. Responsive to determining that the relationship between the resource 304 and the user interface 306 exists, the computing device 302 may (automatically) initiate, trigger and/or launch the second request (e.g., provide the user interface 306 to the user via the client device 102).

Referring now to operation (618), and in some embodiments, the computing device 302 may provide the user with access to the UI 306. Responsive to authentication of the user (e.g., confirming whether the user is an authorized user of the client device 102), the computing device 302 may provide the user with access to the UI 306. In some embodiments, the computing device 302 (or other devices) may authenticate the user with use of (or according to) second credentials (e.g., domain-based credentials, biometric features of the user, an identification number, a digital certificate, an authentication token, a password, a security question, a one-time password, and/or other types of credentials). Authenticated users may perform one or more actions on the resource(s) 304 according to (or based on) RBAC mechanisms. For example, authenticated users may perform a subset of actions on the resources based on the role, privileges, responsibilities and/or position of the user within an enterprise and/or organization, and/or the relationship between the user and the resource(s) 304. In certain embodiments, the second credentials may be separate, different and/or distinct from the first credentials.

Various elements, which are described herein in the context of one or more embodiments, may be provided separately or in any suitable subcombination. For example, the processes described herein may be implemented in hardware, software, or a

combination thereof. Further, the processes described herein are not limited to the specific embodiments described. For example, the processes described herein are not limited to the specific processing order described herein and, rather, process blocks may be re-ordered, combined, removed, or performed in parallel or in serial, as necessary, to achieve the results set forth herein.

It should be understood that the systems described above may provide multiple ones of any or each of those components and these components may be provided on either a standalone machine or, in some embodiments, on multiple machines in a distributed system. The systems and methods described above may be implemented as a method, apparatus or article of manufacture using programming and/or engineering techniques to produce software, firmware, hardware, or any combination thereof. In addition, the systems and methods described above may be provided as one or more computer-readable programs embodied on or in one or more articles of manufacture. The term “article of manufacture” as used herein is intended to encompass code or logic accessible from and embedded in one or more computer-readable devices, firmware, programmable logic, memory devices (e.g., EEPROMs, ROMs, PROMs, RAMs, SRAMs, etc.), hardware (e.g., integrated circuit chip, Field Programmable Gate Array (FPGA), Application Specific Integrated Circuit (ASIC), etc.), electronic devices, a computer readable non-volatile storage unit (e.g., CD-ROM, USB Flash memory, hard disk drive, etc.). The article of manufacture may be accessible from a file server providing access to the computer-readable programs via a network transmission line, wireless transmission media, signals propagating through space, radio waves, infrared signals, etc. The article of manufacture may be a flash memory card or a magnetic tape. The article of manufacture includes hardware logic as well as software or programmable code embedded in a computer readable medium that is executed by a processor. In general, the computer-readable programs may be implemented in any programming language, such as LISP, PERL, C, C++, C#, PROLOG, or in any byte code language such as JAVA. The software programs may be stored on or in one or more articles of manufacture as object code.

While various embodiments of the methods and systems have been described, these embodiments are illustrative and in no way limit the scope of the described methods or systems. Those having skill in the relevant art can effect changes to form and details of the described methods and systems without departing from the broadest scope of the described methods and systems. Thus, the scope of the methods and systems described herein should not be limited by any of the illustrative embodiments and should be defined in accordance with the accompanying claims and their equivalents.

We claim:

1. A method comprising:
receiving, by a computing device, a first request to access a resource, the resource being executable on one or more servers and including data to provision the resource to one or more client devices;
determining, by the computing device, that a relationship between a user of a client device and the resource exists that enables provision of the resource to the client device with use of first credentials defined by an administrative entity of the computing device;
initiating, by the computing device responsive to the determination, a second request to provide a user interface through which to access the resource; and
providing, by the computing device, the user with access to the user interface responsive to authentication of the user with use of second credentials different from the first credentials.

2. The method of claim 1, comprising:
providing, by the computing device in response to determining that the relationship exists, the first credentials to allow the user access to the resource.

3. The method of claim 1, wherein the relationship is preconfigured in a database, the database comprising a plurality of relationships, each being between at least one user and at least one resource.

4. The method of claim 3, wherein the at least one resource includes the user interface.

5. The method of claim 3, wherein the first credentials are configured for use in accordance with each of at least two of the plurality of relationships.

6. The method of claim 1, comprising:
determining, by the computing device, that a relationship between the resource and the user interface exists; and
initiating, by the computing device, the second request responsive to determining that the relationship between the resource and the user interface exists.

7. The method of claim 1, wherein the resource executes on a first subset of the one or more servers, and the user interface executes on a second subset of the one or more servers that is different from the first subset.

8. The method of claim 1, wherein the relationship comprises a relationship between a group of users and the resource, the group of users including the user.

9. The method of claim 1, wherein the relationship comprises a relationship between the user and a plurality of resources, the plurality of resources including the resource.

10. A computing device, comprising:
at least one processor configured to:
receive a first request to access a resource, the resource being executable on one or more servers and including data to provision the resource to one or more client devices;
determine that a relationship between a user of a client device and the resource exists that enables provision of the resource to the client device with use of first credentials defined by an administrative entity of the computing device;
initiate, responsive to the determination, a second request to provide a user interface through which to access the resource; and
provide the user with access to the user interface responsive to authentication of the user with use of second credentials different from the first credentials.

11. The computing device of claim 10, wherein the at least one processor is configured to:
provide, in response to the determination, the first credentials to allow the user access to the resource.

12. The computing device of claim 10, wherein the relationship is preconfigured in a database, the database comprising a plurality of relationships, each being between at least one user and at least one resource.

13. The computing device of claim 12, wherein the at least one resource includes the user interface.

14. The computing device of claim 12, wherein the first credentials are configured for use in accordance with each of at least two of the plurality of relationships.

15. The computing device of claim 10, wherein the at least one processor is configured to:
determine that a relationship between the resource and the user interface exists; and
initiate the second request responsive to determining that the relationship between the resource and the user interface exists.

16. The computing device of claim 10, wherein the resource executes on a first subset of the one or more servers, and the user interface executes on a second subset of the one or more servers that is different from the first subset.

17. The computing device of claim 10, wherein the relationship comprises a relationship between a group of users and the resource, the group of users including the user.

18. The method of claim 10, wherein the relationship comprises a relationship between the user and a plurality of resources, the plurality of resources including the resource.

19. A non-transitory computer-readable medium storing instructions that, when executed by at least one processor, cause the at least one processor to:
receive a first request via a receiver, to access a resource, the resource being executable on one or more servers and including data to provision the resource to one or more client devices;
determine that a relationship between a user of a client device and the resource exists that enables provision of the resource to the client device with use of first credentials defined by an administrative entity of the computing device;
initiate, responsive to the determination, a second request to provide a user interface through which to access the resource; and
provide the user with access to the user interface responsive to authentication of the user with use of second credentials different from the first credentials.

20. The non-transitory computer readable medium of claim 19, wherein the program instructions cause the at least one processor to:
determine that a relationship between the resource and the user interface exists; and
initiate the second request responsive to determining that the relationship between the resource and the user interface exists.
